(19) United States
(12) Patent Application Publication
(10) Pub. No.: US 2025/0145076 A1
(43) Pub. Date: May 8, 2025

(54) Multi-Functional Integrated Living Space Module For Compact Environments

(71) Applicant: Shaun Paul Roy, Spanaway, WA (US)

(72) Inventor: Shaun Paul Roy, Spanaway, WA (US)

(21) Appl. No.: 19/014,489

(22) Filed: Jan. 9, 2025

(51) Int. Cl. B60P 3/36; E04H 1/00

(52) U.S. Cl. CPC B60P 3/36; E04H 1/00

(57) ABSTRACT

A multi-functional integrated living space module integrates kitchen, bathroom, and optional sleeping configurations within the same floor space. The multi-functional unit comprises a base frame positioned within an area, a convertible platform, a kitchen unit, a bathroom unit, and a water management system. This unit is particularly well-suited for applications in camper vans, truck cabins, mini homes, long-haul vehicles, teardrop trailers, and other compact residential or recreational spaces. The multi-functional unit also incorporates a bed that either folds down from a wall or descends vertically on tracks, allowing the same area to function alternately as a kitchen, bathroom, or sleeping space.

### FIELD OF THE INVENTION

The present disclosure relates generally to space-efficient designs for compact living environments, and more particularly to a multi-functional integrated living space module or system that integrates kitchen, bathroom, and optional sleeping configurations within the same floor space.

### BACKGROUND

Compact living spaces, such as camper vans, truck cabins, mini homes, and teardrop trailers, are growing in popularity due to their affordability, mobility, and minimalist lifestyle appeal. However, designing functional interiors for such spaces presents a significant challenge. Users often need to compromise between kitchen and bathroom functionality due to the limited floor area. A compact design that provides both full-sized kitchen and bathroom facilities without sacrificing comfort or utility is highly sought after.

In traditional compact living designs, the kitchen and bathroom often compete for the same limited space. The inclusion of a small, booth-like bathroom with cramped dimensions unsuitable for larger individuals. The exclusion of a bathroom altogether in favor of maximizing kitchen or sleeping space. These compromises fail to provide the comfort and utility needed for long-term habitation or practical use, especially for individuals who require more spacious facilities.

Designs where walls slide to reconfigure a space between a kitchen, bathroom, or sleeping area. Collapsible or foldable countertops, sinks, and toilet setups to alternate between configurations. Systems where a section of the interior pivots horizontally to transform from one functional area to another. Small, prefabricated shower units integrated into living spaces to conserve space.

However, sliding walls and compact shower booths typically result in small, cramped spaces that cannot accommodate taller or larger individuals. Rotating and sliding systems require additional horizontal floor space for movement, which is often unavailable in compact environments. Existing designs often rely on standard water reservoir configurations, requiring significant vertical space for plumbing, drain traps, and reservoir stacking, further reducing usable interior height. Folding furniture designs typically prioritize one function over another, resulting in compromises in usability or structural stability.

Therefore, there is a need for a multi-functional integrated living space module or system that integrates kitchen, bathroom, and optional sleeping configurations within the same floor space. There is also a need for a multi-functional integrated living space module that is particularly suited for applications in camper vans, truck cabins, mini homes, long-haul vehicles, teardrop trailers, and other compact residential or recreational spaces.

### SUMMARY OF THE INVENTION

The following presents a simplified summary of one or more embodiments of the present disclosure to provide a basic understanding of such embodiments. This summary is not an extensive overview of all contemplated embodiments and is intended to neither identify key nor critical elements of all embodiments, nor delineate the scope of any or all embodiments.

The present disclosure, in one or more embodiments, relates to a multi-functional integrated living space module that integrates kitchen, bathroom, and optional sleeping configurations within the same floor space.

In one embodiment of a first aspect, a multi-functional integrated living space module for compact environments. The multi-functional integrated living space module comprises a base frame disposed in an area, a convertible platform, a kitchen unit, a bathroom unit, and a water management system.

In one embodiment of the first aspect, the base frame is configured to form a recess. The convertible platform is mounted on the base frame. The convertible platform includes a top surface and a bottom surface. The convertible platform is configured to cover the recess of the base frame.

In one embodiment of the first aspect, the kitchen unit is disposed on the top surface of the convertible platform. The kitchen unit includes, but is not limited to a stove, a sink, and a first freshwater pipe. The stove is disposed on the top surface of the convertible platform. The stove is configured for cooking food. The sink is positioned adjacent to the stove and disposed on the top surface of the convertible platform. The sink is configured for washing utensils and vegetables. The first freshwater pipe is connected to the sink. The first freshwater pipe is configured to supply fresh water to the sink through a tap.

In one embodiment of the first aspect, the bathroom unit is disposed on the bottom surface of the convertible platform. The bathroom unit comprises a shower unit, a toilet, and a second freshwater pipe. The shower unit is disposed on the bottom surface of the convertible platform. The shower unit is connected to the second freshwater pipe for receiving the fresh water for bathing. The toilet is mounted on a shower floor and disposed within the recess of the base frame.

In one embodiment of the first aspect, the conversion assembly is configured to connect the convertible platform to the base frame. The convertible platform is configured to cover the recess of the base frame. The conversion assembly is configured to move the convertible platform, for converting the convertible platform between a countertop for the kitchen unit and a bathroom wall for the bathroom unit. The conversion assembly includes at least one of a hinge unit, and a sliding unit.

In one embodiment of the first aspect, the conversion assembly includes a hinge unit that is configured to pivotally connect one edge of the convertible platform with one edge of the base frame, thereby enabling the lifting of the convertible platform upwards to reveal the bathroom unit.

In one embodiment of the first aspect, the conversion assembly includes a sliding unit that is configured to slide the convertible platform in at least one direction to expose the bathroom unit beneath the convertible platform. In some embodiments, the conversion assembly is equipped with a locking unit to secure the convertible platform in both lifted and lowered configurations.

In one embodiment of the first aspect, the water management system is connected to the kitchen unit and the bathroom unit. The water management system is configured for supplying and draining domestic water. The water management system includes a clean water reservoir, a wastewater collection reservoir, a sewage holding reservoir, and a drain trap. The clean water reservoir is positioned beneath the shower floor. The wastewater collection reservoir is positioned beneath the clean water reservoir. The sewage holding reservoir is positioned adjacent to the fresh and wastewater collection reservoirs. The wastewater collection reservoir is configured to connect to the drain trap, allowing the drain to extend below the shower floor while conserving vertical space. In one embodiment, the clean water reservoir, the wastewater collection reservoir, and the sewage holding reservoir are arranged in a stacked configuration beneath the shower floor.

In one embodiment of the first aspect, the multi-functional integrated living space module includes a bed. The bed is mounted above the kitchen unit and bathroom unit. The bed is configured to either fold down from a wall or descend vertically on a track, allowing the area to function alternately as a kitchen, bathroom, and sleeping area.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

The accompanying drawings, which are incorporated in and constitute a part of the specification, illustrate in one embodiment of the invention, and, together with the description, explain the principles of the invention.

FIG. 1 illustrates a top view of a camper vehicle with a multi-functional integrated living space module, in accordance with embodiments of the invention.

FIG. 2 illustrates a front view of the multi-functional integrated living space module, in accordance with embodiments of the invention.

FIG. 3A illustrates a perspective view of the multi-functional integrated living space module in a kitchen configuration, in accordance with embodiments of the invention.

FIG. 3B illustrates a perspective view of the multi-functional integrated living space module in the kitchen configuration, in accordance with embodiments of the invention.

FIG. 4A illustrates a perspective view of the multi-functional integrated living space module in a bathroom configuration, in accordance with embodiments of the invention.

FIG. 4B illustrates another perspective view of the multi-functional integrated living space module in the bathroom configuration, in accordance with embodiments of the invention.

FIG. 5A illustrates a schematic view of the water management system for the multi-functional integrated living space module, in accordance with embodiments of the invention.

FIG. 5B illustrates another schematic view of the water management system for the multi-functional integrated living space module, in accordance with embodiments of the invention.

### DETAILED DESCRIPTION

Reference will now be made in detail to the present preferred embodiments of the invention, examples of which are illustrated in the accompanying drawings. Wherever possible, the same reference numerals are used in the drawings and the description to refer to the same or like parts.

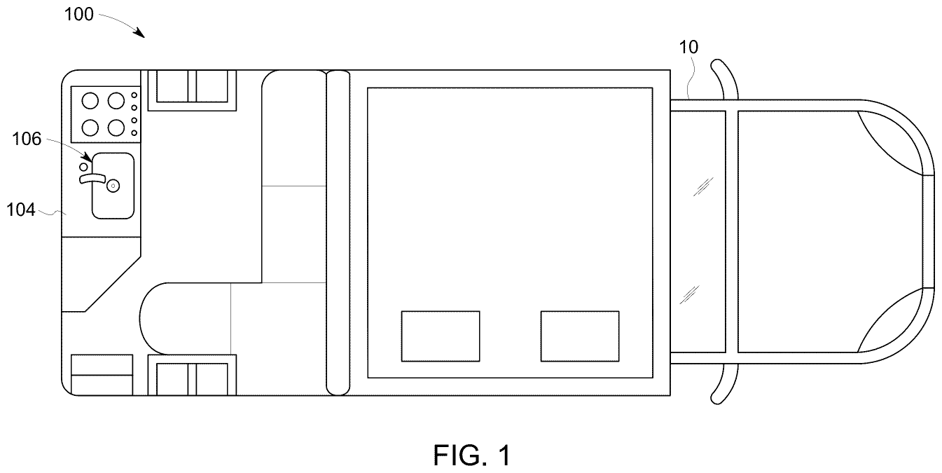

FIG. 1 refers to a top view of a camper vehicle 10 with a multi-functional integrated living space module 100. The camper vehicle 10 comprises the multi-functional integrated living space module 100 for compact environments. The multi-functional integrated living space module 100 could be a multi-functional integrated living space module. In one embodiment herein, the multi-functional integrated living space module 100 comprises a base frame 102 disposed in an area, a convertible platform 104, a kitchen unit 106, a bathroom unit 108, a conversion assembly 110 and a water management system 112.

In one embodiment, the multi-functional integrated living space module 100 is designed to optimize living spaces by integrating multiple essential living configurations into a single, unified unit. The integrated living space module 100 combines key configurations required for daily living such as, a kitchen configuration for cooking and meal preparation, a bathroom configuration for personal hygiene and sanitation, and a sleeping configuration for rest and relaxation into a cohesive and space-efficient design. Such an arrangement is particularly advantageous in environments where maximizing the use of limited floor space is of critical importance.

The multi-functional integrated living space module 100 is especially suitable for compact living settings, such as camper vans, truck campers, recreational vehicles (RVs), and other mobile or space-constrained housing solutions. By consolidating these essential facilities into a streamlined unit, the integrated living space module 100 significantly reduces the area typically required for separate kitchen, bathroom, and sleeping arrangements, thus enhancing both functionality and usability in small environments.

In one embodiment herein, the conversion assembly 110 enables seamless and secure transitions between the different configurations. The conversion assembly 110 ensures that users can easily switch between modes, such as transforming the sleeping configuration into the kitchen configuration or converting the kitchen configuration into the bathroom configuration, without compromising on safety, stability, or convenience. This flexibility enhances the practicality of the integrated living space module 100, making it an ideal solution for those seeking efficient, multi-functional living spaces.

In one embodiment, the base frame 102 and the convertible platform 104 are designed for robust operation in mobile environments, with mechanisms to resist vibrations and movement during transit.

In some embodiment, the kitchen unit 106, and the bathroom unit 108 are configured with dedicated plumbing systems to prevent cross-contamination. Further, the integrated living space module 100 comprises safety features, such as position sensors and controlled lifting/lowering mechanisms, ensure secure operation and prevent accidents.

In another embodiment, the integrated living space module 100 is suitable for a wide range of environments, including camper vans, teardrop trailers, mini homes, and other compact residential or recreational spaces. Further, the customizable configurations allow the integrated living space module 100 to adapt to user-specific requirements.

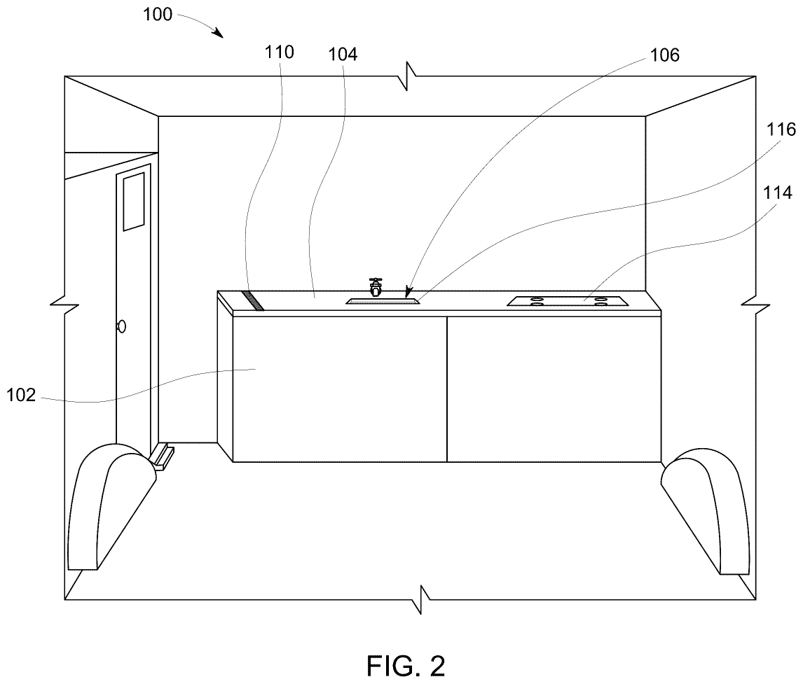

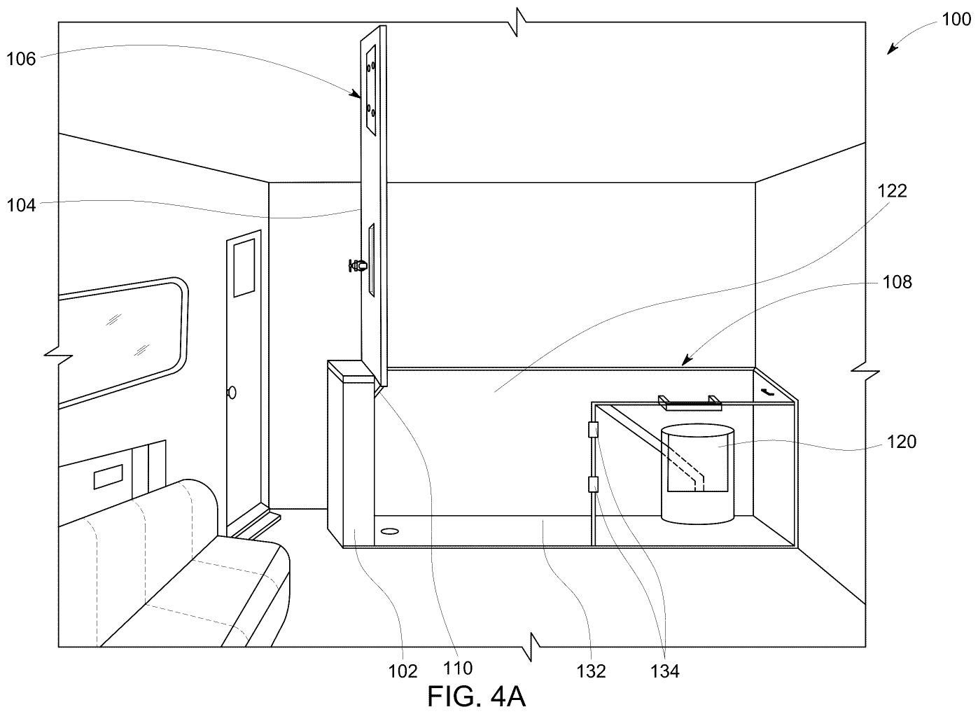

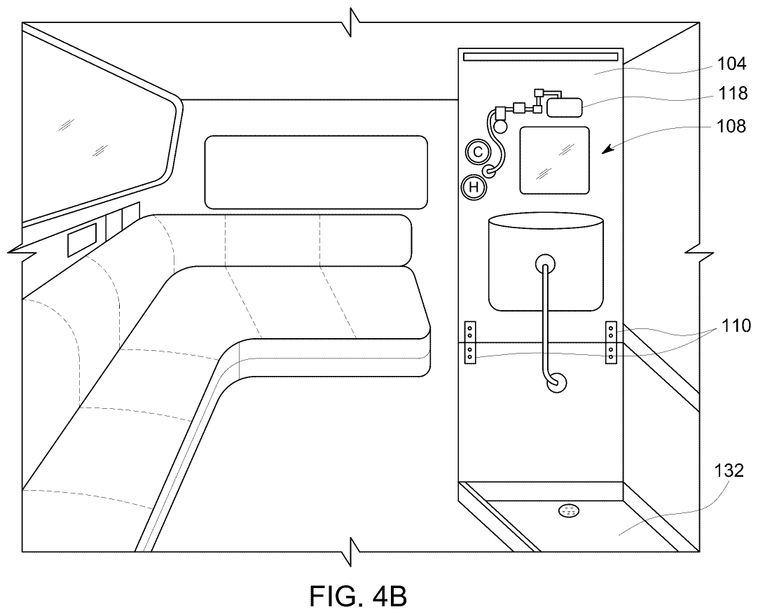

FIG. 2 refers to a front view of the integrated living space module 100. The base frame 102 is configured to form a recess 122 (shown in FIG. 4A). The convertible platform 104 is mounted on the base frame 102. The convertible platform 104 includes a top surface and a bottom surface. The convertible platform 104 is configured to cover the recess 122 of the base frame 102.

In one embodiment, the convertible platform 104 serves dual purposes, functioning as a countertop in the kitchen configuration and as a covering for the bathroom configuration when not in use.

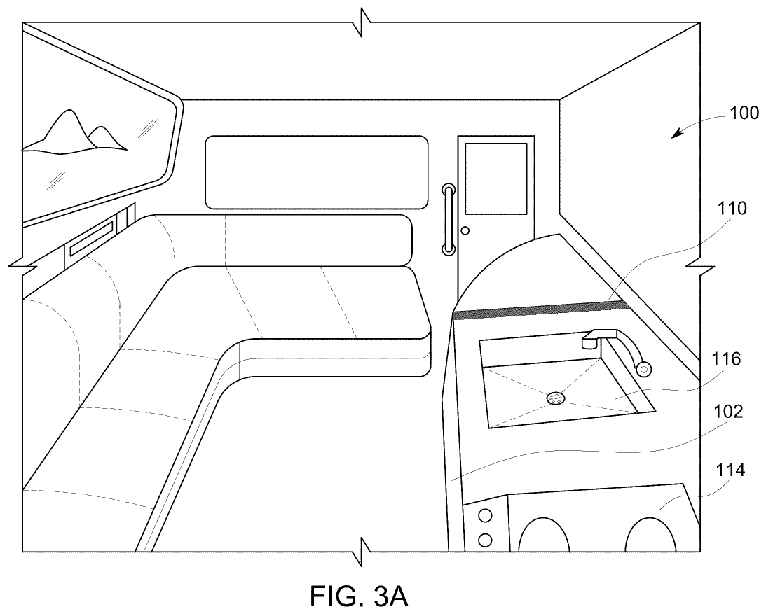

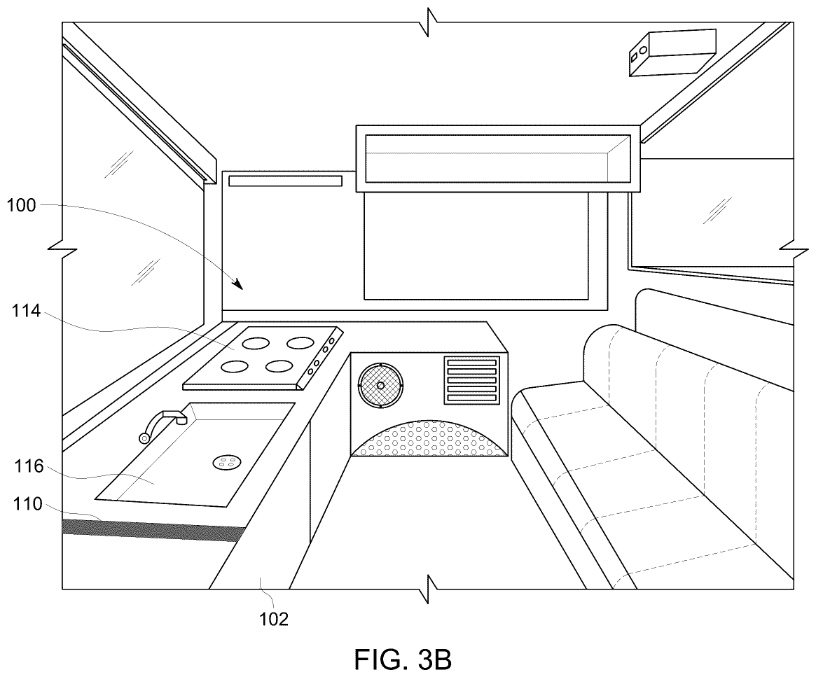

FIG. 3A refers to a perspective view of the integrated living space module 100 in a kitchen configuration. The kitchen unit 106 is positioned on the top surface of the convertible platform 104, offering a compact yet functional design tailored for space-constrained living environments. The kitchen unit 106 is configured to serve as a fully equipped culinary workspace, enabling users to perform essential cooking and cleaning tasks efficiently. The kitchen unit 106 includes, but is not limited to a stove 114, a sink 116, and a first freshwater pipe.

In one embodiment, the ergonomic placement of kitchen components (the stove 114, and the sink 116) ensures efficient workflow for cooking and cleaning activities.

In some embodiments, the convertible platform 104 is designed with a width of 50 to 70 inches and a depth of 20 to 30 inches to accommodate the stove 114, and the sink 116.

FIG. 3B refers to another perspective view of the integrated living space module 100 in the kitchen configuration. The stove 114 is mounted securely on the top surface of the convertible platform 104. The stove 114 is configured for cooking food, placement of the stove 114 allows easy access during meal preparation while maintaining stability during use. In some embodiments, the stove 114 is powered by various energy sources comprise, but are not limited to, gas, electricity, or induction, to suit the specific needs of the environment in which the unit is installed.

In one embodiment, the sink 116 is positioned adjacent to the stove 114 and disposed on the top surface of the convertible platform 104. This arrangement ensures a seamless workflow for cooking and cleaning activities, minimizing the need for extensive movement within the compact space. The sink 116 is configured for washing utensils, vegetables, and other items essential for meal preparation. The sink 116 ensures case of use, with sufficient depth and size to accommodate a variety of washing needs.

In one embodiment, the sink 116 is connected to a first freshwater pipe, which supplies clean water through a tap integrated into the sink 116. The first freshwater pipe is part of a dedicated plumbing system, designed to deliver potable water directly to the sink for hygienic and convenient use. In some embodiments, the first freshwater pipe also includes filtration components or water heaters, depending on the specific implementation, to enhance functionality.

In some embodiments, the kitchen configuration of the kitchen unit 106 highlights a thoughtful design approach, ensuring that essential cooking and cleaning utilities are efficiently integrated into a single platform. The strategic placement of the stove 114 and the sink 116, coupled with the functionality provided by the first freshwater pipe, supports an organized and user-friendly kitchen experience within a compact living space.

FIG. 4A refers to a perspective view of the integrated living space module 100 in a bathroom configuration. The bathroom unit 108 is disposed on the bottom surface of the convertible platform 104. The bathroom unit 108 is integrated into the convertible platform 104 to maximize space efficiency in compact living environments. This integration allows the bathroom facilities to remain concealed when not in use, preserving valuable floor space for other functionalities.

In one embodiment, the bathroom configuration provides a larger-than-standard shower area suitable for individuals up to 6′2″ and 300 lbs, distinguishing it from smaller, booth-style showers common in compact living spaces.

FIG. 4B refers to another perspective view of the integrated living space module 100 in the bathroom configuration. The bathroom unit 108 comprises a shower unit 118, a toilet 120, and a second freshwater pipe. The shower unit 118 is disposed on the bottom surface of the convertible platform 104, effectively utilizing otherwise underutilized space. The shower unit 118 is connected to the second freshwater pipe that supplies clean water specifically for bathing purposes. The second freshwater pipe is part of a dedicated water distribution system designed to separate freshwater used for personal hygiene from other water systems in the structure, ensuring convenience and hygiene.

In one embodiment, the toilet 120 is mounted on a shower floor 132 and disposed within the recess 122 of the base frame 102. The recess 122 serves as a structural housing for the toilet 120, ensuring it remains flush with the shower floor 132 when not in use. This bathroom configuration minimizes obstructions in the shower area while maintaining functional accessibility. Overall, the layout and integration of the bathroom unit 108 demonstrate thoughtful engineering to accommodate essential facilities in a compact yet practical manner, catering to the unique needs of space-constrained living spaces.

In one embodiment, the conversion assembly 110 is configured to connect the convertible platform 104 to the base frame 102, enabling versatile functionality in a compact space. The convertible platform 104 is configured to act as a dual-purpose component such as the countertop for the kitchen unit 106 and a covering surface for the recess 122 of the base frame 102, which houses the bathroom unit 108. The conversion assembly 110 is configured to move the convertible platform 104, for converting the convertible platform 104 between a countertop for the kitchen unit 106 and a bathroom wall for the bathroom unit 108. The conversion assembly 110 includes at least one of a hinge unit, and a sliding unit.

In another embodiment, the conversion assembly 110 includes a hinge unit that is configured to pivotally connect one edge of the convertible platform 104 to a corresponding edge of the base frame 102. The conversion assembly 110 allows the convertible platform 104 to be lifted upward, effectively exposing the bathroom unit 108 beneath. The hinge unit is designed for smooth and reliable movement, incorporating durable materials and precision engineering to withstand repeated use.

In some embodiments, the hinge unit can be further enhanced with features such as dampers or gas struts, which provide controlled lifting and lowering of the convertible platform 104. These features minimize the effort required by the user and ensure safe operation, preventing sudden drops or unintentional closures. In addition, locking positions can be incorporated at various angles to allow partial lifting for inspection or full access for usage.

In another embodiment, the conversion assembly 110 includes a sliding unit that is configured to slide the convertible platform 104 horizontally or in another defined direction to expose the bathroom unit 108 beneath the convertible platform 104. The sliding unit is particularly useful in scenarios where vertical space is constrained or where a smoother, less obstructive transition is desired.

In some embodiments, the sliding unit is equipped with rails or tracks that guide the motion of the convertible platform 104, ensuring stability and precision. Depending on the design, the sliding action can be manual or automated, with options for soft-close or self-retraction to enhance usability. The sliding unit may also include locking features to secure the convertible platform 104 in its closed or open position, preventing unintentional movement during operation or transit.

In some embodiments, both the hinge and sliding units are augmented with advanced features to enhance functionality and user experience. Further, motors or actuators are integrated into the conversion assembly 110, enabling push-button or remote-controlled transitions. Furthermore, sensors can detect the position of the convertible platform 104 and ensure that the convertible platform 104 is securely locked in place before use, providing visual or auditory feedback to the user. Some embodiments may combine hinge and sliding units, allowing for both lifting and sliding movements to accommodate specific use cases or spatial constraints.

In one embodiment, the conversion assembly 110 is equipped with a locking unit 134 designed to securely hold the convertible platform 104 in both a lifted configuration and a lowered configuration, ensuring safety, stability, and convenience during operation. The locking unit 134 is a critical component, particularly in applications where the convertible platform 104 transitions between multiple functional states, such as from a kitchen workspace to a concealed bathroom or storage area.

In one embodiment, the locking unit 134 is configured to engage firmly with the convertible platform 104 and the base frame 102, preventing unintended movement or displacement during use. In the lifted configuration, the locking unit 134 maintains the convertible platform 104 at a stable height, allowing users to access the recess 122, such as the bathroom unit 108. This is particularly beneficial in compact living environments, where efficient use of vertical space is essential.

In the lowered configuration, the locking unit 134 ensures that the convertible platform 104 remains securely in place, providing a stable surface for activities like cooking, working, or dining. The locking unit 134 is designed to resist vibrations, tilting, or shifting, especially during transit in mobile environments like camper vans or truck campers.

In another embodiment, the base frame 102 is further equipped with a cover plate strategically positioned on its front side. The cover plate is configured to enhance an aesthetic appeal of the structure by providing a seamless, finished appearance, and it functions as a practical barrier to conceal the bathroom unit 108 located beneath the convertible platform 104. When the kitchen unit 106 is in use, the cover plate ensures that the bathroom unit 108 remains hidden from view, maintaining a clean and organized visual profile. The cover plate is pivotally attached to the base frame 102 using either a hinge unit or a sliding unit, providing versatile movement options. This attachment mechanism allows the cover plate to pivot or slide as needed, enabling easy access to the bathroom unit 108 concealed beneath the convertible platform 104.

The locking unit 134 may include various mechanisms, such as mechanical latches, sliding bolts, or magnetic locks, depending on the specific requirements of the embodiment. For enhanced case of use, the locking unit 134 is integrated with a manual or automated release mechanism. A manual release may involve a lever or button, while an automated release could be driven by motors or actuators controlled through a user interface, such as a control panel or a mobile application.

In some embodiments, the locking unit 134 may include sensors to verify the engagement status and ensure the convertible platform 104 is securely locked before operation. These sensors can be integrated with an alert system to notify users if the convertible platform 104 is not properly secured, enhancing safety. By incorporating the locking unit 134, the conversion assembly 110 provides a reliable and user-friendly mechanism to stabilize the convertible platform 104, accommodating various use scenarios while prioritizing safety and functionality.

In one embodiment, the the locking unit 134 for the convertible platform 104 enhance safety and stability in both lifted and lowered positions.

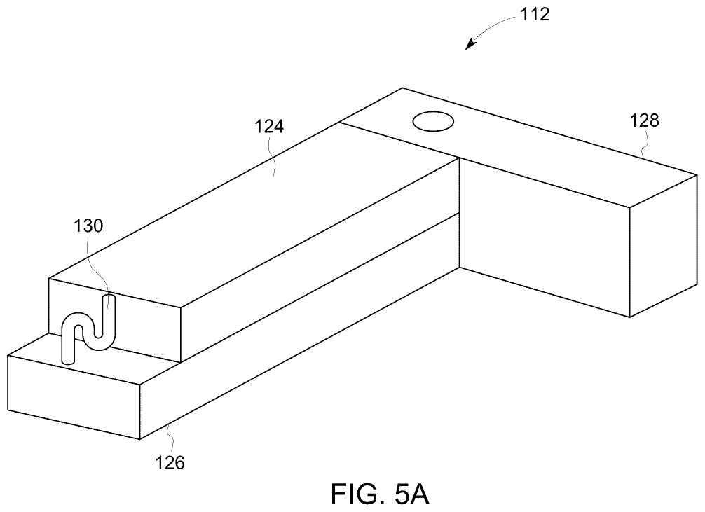

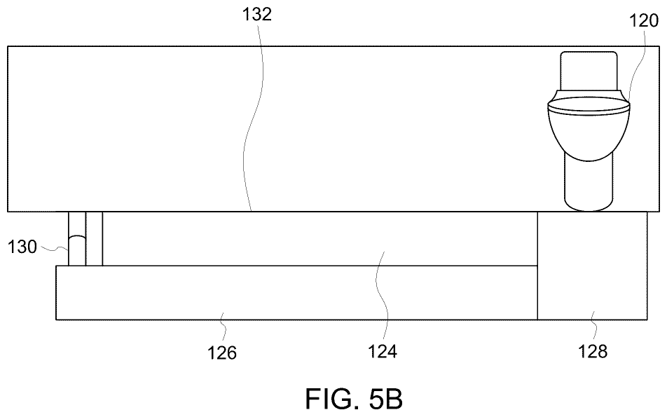

FIG. 5A refers to a schematic view of the water management system 112 for the integrated living space module 100. The water management system 112 is connected to the kitchen unit 106 and the bathroom unit 108. The water management system 112 is configured for supplying and draining domestic water. The water management system 112 includes a clean water reservoir 124, a wastewater collection reservoir 126, a sewage holding reservoir 128, and a drain trap 130.

FIG. 5B refers to another schematic view of the water management system 112 for the integrated living space module 100. The clean water reservoir 124 is positioned beneath the shower floor 132. The wastewater collection reservoir 126 is positioned beneath the clean water reservoir. The sewage holding reservoir 128 is positioned adjacent to the fresh reservoir 124 and the wastewater collection reservoir 126. The wastewater collection reservoir 126 is configured to connect to the drain trap 130, allowing the drain to extend below the shower floor 132 while conserving vertical space.

In one embodiment, the clean water reservoir 124, the wastewater collection reservoir 126, and the sewage holding reservoir 128 are arranged in a stacked configuration beneath the shower floor 132. The stacked arrangement of the water management system 112 beneath the shower floor 132 conserves vertical space while maintaining functionality. The stacked arrangement of the clean water reservoir 124, the wastewater collection reservoir 126, and the sewage holding reservoir 128 ensures a compact design that minimizes the system's footprint.

In one embodiment, the integrated living space module 100 includes a bed (not shown). The bed is mounted above the kitchen unit 106 and bathroom unit 108. The bed is configured to either fold down from a wall or descend vertically on a track, allowing the area to function alternately as a kitchen, bathroom, and sleeping area. The bed is positioned to rest above the kitchen unit 106 and bathroom unit 108 when not in use, ensuring these areas remain fully accessible during daytime activities.

In some embodiments, depending on the specific embodiment, the bed can be configured to deploy in one of two primary ways such as a wall-folding configuration, and a vertical descending configuration.

In the wall-folding configuration, the bed is mounted on a wall and is designed to fold down when needed. When stowed, the bed is either flush with the wall or recessed into a designated cavity, minimizing its impact on available space. The folding mechanism may include hinges, gas struts, or spring-assisted arms to enable smooth and effortless operation. To ensure safety and functionality, the folding mechanism incorporates secure locking systems to hold the bed firmly in place when stowed or deployed. In some designs, the underside of the folded bed can double as a decorative wall panel or storage space, adding to its multi-functionality.

In some alternative embodiments, the bed can be designed to descend vertically along a track system mounted to the walls or ceiling. This configuration is ideal for maximizing floor space since the bed remains elevated when not in use. The descending mechanism can be manual or automated. In manual systems, counterweights or spring-assist systems reduce the effort required to lower or lift the bed. Automated systems use motors and tracks for smooth and precise vertical movement, often controlled via a wall-mounted switch, remote control, or mobile application. Safety features such as position sensors and locking mechanisms ensure the bed remains stable during use and secure when retracted.

In some embodiments, the bed dimensions may be configurable, with example dimensions of 55 inches in width and 65 inches in length, designed to accommodate one or two users based on the selected orientation.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principles of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

It will readily be apparent that numerous modifications and alterations can be made to the processes described in the foregoing examples without departing from the principles underlying the invention, and all such modifications and alterations are intended to be embraced by this application.

The claimed invention is:

1. A multi-functional integrated living space module for compact environments, comprising:
a base frame disposed in an area, wherein the base frame is configured to form a recess;
a convertible platform mounted on the base frame, wherein the convertible platform comprises a top surface and a bottom surface, wherein the convertible platform is configured to cover the recess of the base frame;
a kitchen unit disposed on the top surface of the convertible platform;
a bathroom unit comprises:
a shower unit disposed on the bottom surface of the convertible platform; and
a toilet mounted on a shower floor, and disposed within the recess of the base frame;
a conversion assembly configured to move the convertible platform for converting the convertible platform between a countertop for the kitchen unit and a bathroom wall for the bathroom unit; and
a water management system connected to the kitchen unit and the bathroom unit, wherein the water management system is arranged in a stacked configuration beneath the shower floor for supplying and draining domestic water.

2. The multi-functional integrated living space module of claim 1, wherein the kitchen unit comprises:
a stove disposed on the top surface of the convertible platform, wherein the stove is configured for cooking foods;
a sink positioned adjacent to the stove, and disposed on the top surface of the convertible platform, wherein the sink is configured for washing utensils and vegetables; and
a first freshwater pipe connected to the sink, wherein the freshwater pipe is configured to supply fresh water to the sink through a tap.

3. The multi-functional integrated living space module of claim 1, wherein the shower unit is connected to a second freshwater pipe for receiving the fresh water for bathing.

4. The multi-functional integrated living space module of claim 1, wherein the conversion assembly comprises at least one of a hinge unit and a sliding unit.

5. The multi-functional integrated living space module of claim 4, wherein the hinge unit is configured to pivotally connect one edge of the convertible platform with one edge of the base frame, thereby enabling lifting of the convertible platform upwards to reveal the bathroom unit.

6. The multi-functional integrated living space module of claim 4, wherein the sliding unit is configured to slide the convertible platform in at least one direction to expose the bathroom unit beneath the convertible platform.

7. The multi-functional integrated living space module of claim 1, wherein the conversion assembly is equipped with a locking unit to secure the convertible platform in both lifted and lowered configurations.

8. The multi-functional integrated living space module of claim 1, wherein the water management system comprises:
a clean water reservoir positioned beneath the shower floor;
a wastewater collection reservoir positioned beneath the clean water reservoir; and
a sewage holding reservoir positioned adjacent to the clean water and wastewater collection reservoirs, wherein the wastewater collection reservoir is configured to connect to a drain trap to allow the drain to extend below the shower floor while conserving vertical space.

9. A multi-functional integrated living space module for compact environments, comprising:
a base frame disposed in an area, wherein the base frame is configured to form a recess;
a convertible platform mounted on the base frame, wherein the convertible platform comprises a top surface and a bottom surface, wherein the convertible platform is configured to cover the recess of the base frame;
a kitchen unit disposed on the top surface of the convertible platform, wherein the kitchen unit comprises:
a stove disposed on the top surface of the convertible platform, wherein the stove is configured for cooking foods; and
a sink positioned adjacent to the stove, and disposed on the top surface of the convertible platform, wherein the sink is configured for washing utensils and vegetables;
a bathroom unit comprises:
a shower unit disposed on the bottom surface; and
a toilet mounted on a shower floor, and disposed within the recess;
a conversion assembly configured to move the convertible platform, for converting the multi-functional unit between a kitchen configuration and a bathroom configuration;
a water management system connected to the kitchen unit and the bathroom unit, wherein the water management system comprises:
a clean water reservoir positioned beneath the shower floor;
a wastewater collection reservoir positioned beneath the clean water reservoir; and
a sewage holding reservoir positioned adjacent to the clean water and wastewater collection reservoirs, wherein the wastewater collection reservoir is configured to connect to a drain trap, allowing the drain to extend below the shower floor while conserving vertical space; and
a bed mounted above the kitchen unit and bathroom unit, wherein the bed is configured to either fold down from a wall or descend vertically on a track, allowing the area to function alternately as a kitchen, bathroom, and sleeping area.

10. The multi-functional integrated living space module of claim 9, wherein the kitchen unit comprises a first freshwater pipe connected to the sink, wherein the freshwater pipe is configured to supply fresh water to the sink through a tap.

11. The multi-functional integrated living space module of claim 9, wherein the shower unit is connected to a second freshwater pipe for receiving the fresh water for bathing.

12. The multi-functional integrated living space module of claim 9, wherein the conversion assembly comprises at least one of a hinge unit and a sliding unit.

13. The multi-functional integrated living space module of claim 12, wherein the hinge unit is configured to pivotally connect one edge of the convertible platform with one edge of the base frame, thereby enabling lifting of the convertible platform upwards to reveal the bathroom unit.

14. The multi-functional integrated living space module of claim 12, wherein the sliding unit is configured to slide the convertible platform in at least one direction to expose the bathroom unit beneath the convertible platform.

15. The multi-functional integrated living space module of claim 9, wherein the conversion assembly is equipped with a locking unit to secure the convertible platform in both lifted and lowered configurations.
